(19) United States
(12) Patent Application Publication
(10) Pub. No.: US 2004/0067313 A1
(43) Pub. Date: Apr. 8, 2004

(54) Process for applying a coating to untreated metal substrates

(76) Inventor: Brian T. Hauser, Murrysville, PA (US)

Correspondence Address: PPG INDUSTRIES, INC., Intellectual Property Department, One PPG Place, Pittsburgh, PA, 15272, US

(21) Appl. No.: 10/263,517

(22) Filed: Oct. 3, 2002

(51) Int. Cl. B05D 3/10; B05D 1/18

(52) U.S. Cl. 427/304; 427/430.1

(57) ABSTRACT

An improved process for applying a coating by means other than electrodeposition to an untreated ferrous metal substrate is disclosed. The substrate need not be phosphated prior to treatment. The process includes contacting the substrate surface with a Group IIIB and/or IVB metal-containing compound in a medium that is essentially free of accelerators, phosphate, zinc, and polymeric material, and coating the substrate by non-electrolytic means. This composition is then cured by conventional means. Substrates treated by the process of the present invention demonstrate excellent corrosion resistance and are also disclosed herein.

### FIELD OF THE INVENTION

This invention relates generally to corrosion-resistant coated metal substrates and, more particularly, to ferrous and non-ferrous metal substrates having an environmentally friendly chrome-free and nickel-free pretreatment that inhibits corrosion of the metal substrate.

### BACKGROUND OF THE INVENTION

Pretreating metal substrates with a phosphate conversion coating and rinsing with a chrome-containing sealer is well known for promoting corrosion resistance and improving the adhesion of subsequently applied decorative and protective coatings. Cationic electrodeposition compositions are often applied over phosphated steel substrates to further improve corrosion resistance. While the combination of a phosphate conversion coating and an electrodeposited coating provides superior corrosion resistance, heavy metals typically used in such coatings can provide environmental disposal concerns. For example, phosphate conversion coating compositions typically contain heavy metals such as nickel, and post-rinses contain chrome. Cationic electrodeposition compositions typically are formulated with lead as a pigment or soluble lead salt, and use of electrodeposition is not desired or appropriate in many applications. Also, conventional phosphating processes can require 11 to 25 stages that occupy a large amount of physical space in a plant and require significant capital investment. Another drawback of conventional phosphating processes is difficulty in coating mixed-metal objects including aluminum.

In addition, many pretreatment and post-rinse compositions are suitable for use over a limited number of substrates or over substrates that must be phosphated first, or are not suitable for use without some other treatment.

It would be desirable to provide a simplified pretreatment process free of heavy metals for coating metal substrates, including mixed metal substrates such as those commonly found on today's automobile bodies. Such a pretreatment process, when combined with heavy metal-free coatings, would provide an environmentally friendly alternative for providing corrosion resistance to metal substrates.

### SUMMARY OF THE INVENTION

The present invention is directed to a method for coating an untreated metal substrate by contacting the substrate with a Group IIIB and/or IVB metal-containing compound. Following the contacting step, the substrate is coated with a composition comprising a film-forming resin. The resin can then be cured by any appropriate means.

It is significant that the present methods are directed to “untreated” metal substrates. As used herein, the term untreated means a bare metal surface; that is, the metal surface has not been phosphated or subjected to any other type of conversion coating. Following contact with the Group IIIB and/or IVB metal-containing compound, the substrate is then rinsed and/or directly coated with, for example, a pigmented coating comprising a film-forming resin; the coating is not an electrodeposited coating. Thus, no additional treatment is needed before application of the coating. Because of the reduced number of process steps, the present methods are therefore particularly suitable for those operations that do not have the facilities for more than one pretreatment application. The coated substrates resulting from the present methods exhibit corrosion resistance that is good and acceptable in many applications. Thus, the present methods are also particularly suitable for those applications that may not require the most stringent corrosion resistance. It is significant that this corrosion resistance is achieved with the use of chrome-free and heavy metal-free pretreatment solutions, and without any other treatment steps; not every pretreatment solution will work by itself. It is also significant that the level of corrosion resistance demonstrated herein can be achieved using coatings other than electrodeposited coatings or “E-coats”; this is a surprising result because E-coats are known in the art as imparting much greater corrosion resistance than other types of coatings. Another benefit of the present invention is that the pretreatment composition described herein can be applied at room temperature; many other pretreatment solutions, in contrast, must be heated before use. The present invention is therefore also more energy efficient than many methods known in the art. Thus, an environmentally friendly method is provided, wherein corrosion resistance is not sacrificed.

### DETAILED DESCRIPTION OF THE INVENTION

The present invention is directed to a method for applying a coating to an untreated metal substrate comprising contacting the substrate with a Group IIIB and/or IVB metal-containing compound in a medium, and coating the substrate with a composition comprising a film-forming resin. Coating is achieved by nonelectrodeposited means.

Both ferrous and non-ferrous metal substrates can be treated according to the present invention. Examples of ferrous metals include cold rolled steel substrates, galvanized steel substrates, including electrogalvanized steel, hot dipped galvanized steel, galvanneal (an Fe/Zn alloy), and stainless steel. Nonferrous metals include, for example, aluminum, magnesium, and copper. It will be appreciated that many substrates that are suitable for treatment according to the present invention will include both ferrous and non-ferrous metals (i.e. “mixed metals”). For example, many automobile assemblies contain both galvanized steel and aluminum. It is an advantage of the present invention that the same composition can be used to treat all of these substrates, with suitable corrosion protection being offered to each. In addition, the untreated metal substrate suitable for use in the present methods may be a cut edge of a substrate that is otherwise treated and/or coated over the rest of its surface.

The substrate to be coated is usually first cleaned to remove grease, dirt, or other extraneous matter. This is done with conventional cleaning procedures and materials, including mild or strong alkaline cleaners that are commercially available and conventionally used in metal pretreatment processes. Examples of alkaline cleaners include CHEMKLEEN 163 and CHEMKLEEN 177, both of which are available from PPG Industries, Inc. Such cleaners are generally followed and/or preceded by a water rinse.

Following the optional cleaning step, the metal surface is contacted with a Group IIIB and/or IVB metal-containing compound.

The Group IIIB and/or IVB metal-containing compound is typically in a medium, such as an aqueous medium, usually in the form of an aqueous solution or dispersion depending on the solubility of the metal compound being used. The term “Group IIIB and/or IVB metal-containing compound” refers, therefore, to a medium containing at least one Group IIIB or IVB metal, and “medium” refers to a solution or dispersion. The aqueous solution or dispersion of the Group IIIB and/or IVB metal may be applied to the metal substrate by known application techniques, such as dipping or immersion, which is particularly suitable; spraying, intermittent spraying, dipping followed by spraying or spraying followed by dipping can also be used. Typically, the medium is applied to the metal substrate at a temperature ranging from ambient to 150° F. (ambient to 65° C.); use of the medium at ambient temperature gives good results. A reduction of energy requirements can therefore be realized by use of the present methods, which can be run at room temperature, as compared to other methods in which the treatment solutions must be heated to 140° F. or higher to be effective. The contact time is generally between 10 seconds and 5 minutes, such as between 30 seconds and 2 minutes when dipping the metal substrate in the medium or when the medium is sprayed onto the metal substrate.

The IIIB and IVB transition metals and rare earth metals referred to herein are those elements included in such groups in the CAS Periodic Table of the Elements as is shown, for example, in the Handbook of Chemistry and Physics, 63rd Edition (1983). Group IIIB will be understood to include the lanthanides and actinides.

Especially suitable Group IIIB and IVB transition metal compounds and rare earth metal compounds are those that contain zirconium, titanium, hafnium, yttrium, cerium and mixtures thereof. Typical zirconium compounds may be selected from hexafluorozirconic acid and alkali metal and ammonium salts thereof, ammonium zirconium carbonate, zirconyl nitrate, zirconium carboxylates and zirconium hydroxy carboxylates such as hydrofluorozirconic acid, zirconium acetate, zirconium oxalate, ammonium zirconium glycolate, ammonium zirconium lactate, ammonium zirconium citrate, and mixtures thereof; zirconium is not present in the form of zirconium acetylacetonate. Hexafluorozirconic acid is especially suitable. An example of a titanium compound is fluorotitanic acid and its salts. An example of a hafnium compound is hafnium nitrate. An example of a yttrium compound is yttrium nitrate. An example of a cerium compound is cerous nitrate. Mixtures of any of the Group IIIB and IVB metals can be used. When the substrate being treated is aluminum, however, the pretreatment solution does not contain both fluoride and either zirconium, hafnium, or titanium. Also, the Group IIIB and IVB metals are not dissolved or dispersed finely divided forms of the metals, but rather are water-soluble or water-dispersible metal salts.

The Group IIIB or IVB metal compound is present in the medium in an amount of 10 to 5000 ppm metal, such as 100 to 500 ppm metal. The pH of the aqueous medium usually ranges from 2.0 to about 7.0, preferably about 3.5 to 5.5. The pH of the medium may be adjusted using mineral acids such as hydrofluoric acid, fluoroboric acid, phosphoric acid, and the like, including mixtures thereof; organic acids such as lactic acid, acetic acid, citric acid, or mixtures thereof; and water soluble or water dispersible bases such as sodium hydroxide, ammonium hydroxide, ammonia, or amines such as triethylamine, methylethyl amine, diisopropanolamine, or mixtures thereof.

The medium may optionally contain other materials such as nonionic surfactants and auxiliaries conventionally used in the art of pretreatment. In an aqueous medium, water dispersible organic solvents, for example, alcohols with up to about eight carbon atoms such as methanol, isopropanol, and the like, may be present, or glycol ethers such as the monoalkyl ethers of ethylene glycol, diethylene glycol, or propylene glycol, and the like. When present, water dispersible organic solvents are typically used in amounts up to about ten percent by volume, based on the total volume of aqueous medium.

Other optional materials include surfactants that function as defoamers or substrate wetting agents. Anionic, cationic, amphoteric, or nonionic surfactants may be used. Compatible mixtures of such materials are also suitable. Defoaming surfactants are typically present at levels up to about 1 percent, such as up to about 0.1 percent by volume, and wetting agents are typically present at levels up to about 2 percent, such as up to about 0.5 percent by volume, based on the total volume of medium.

The Group IIIB and/or IVB metal-containing compound specifically excludes, and therefore is essentially free, of a number of additives used in other pretreatment compositions. “Essentially free” means less than about 0.01 weight percent, (i.e. <100 ppm). Because the present methods are for untreated substrates, there is no need for the Group IIIB/IVB metal-containing compound to contain accelerators used in the formation of phosphate, oxide or other conversion coatings. Accordingly, the medium is essentially free of accelerators needed to form phosphate, oxide or other conversion coatings. Such accelerators include hydroxylamine, sodium nitrite, metals from Groups VA and VIA of the Periodic Table, and other accelerators known in the art.

The medium used in the present invention is also substantially free of phosphates, particularly phosphates of other metals such as zinc, iron and other metals typically used in phosphating pretreating processes. “Phosphate” is intended to include any phosphorus-containing compound, including phosphoric acid.

The medium used in the present invention is also essentially free from zinc in a concentration of from 1 to 30 grams per liter.

Finally, the medium used in the present methods is essentially free of polymeric material. This includes any kind of polymeric material or organic film-forming composition. Specifically excluded are, for example, polyacrylic acids, polyphenols, and polyamides. Also specifically excluded are the polymeric materials described in U.S. Pat. Nos. 3,912,548; 4,376,000; 4,457,790; 4,517,028; 4,944,812; 4,963,596; 4,970,264; 5,039,770; 5,063,089; 5,116,912; 5,129,967; 5,328,525; 5,342,456; 5,449,414; 5,449,415; 5,662,746; 5,801,217; 5,804,652; 5,859,106; 5,859,107; 5,905,105; 6,168,868; 6,217,674; 6,312,812; WO95/33969; WO96/27034 and JP Tokkai 11-061432, all of which are incorporated by reference herein.

In an additional embodiment, no oxyanions are included in the Group IIIB and/or IVB metal-containing compound.

The present invention is further directed to a method for coating an untreated metal substrate comprising a) contacting the substrate with a composition consisting essentially of a Group IIIB and/or IVB metal-containing compound, and b) coating the substrate with a composition comprising a film-forming resin by non-electrolytic means. A composition “consisting essentially of a Group IIIB and/or IVB metal-containing compound” is one that contains the Group IIIB and/or IVB metal-containing compound described above, and any of the other surfactants or other conventional additives described herein, but does not include any other active ingredient reported in the art as contributing to or facilitating corrosion resistance.

The film coverage of the residue of the pretreatment medium composition generally ranges from about 1 to about 1000 milligrams per square meter (mg/m²), such as about 10 to about 400 mg/m². The thickness of the coating can vary, but is generally less than about 1 micrometer, such as from about 1 to about 500 nanometers, or about 10 to about 300 nanometers.

Other optional steps may be included in the process of the present invention. For example, the metal surface may be rinsed with an aqueous acidic solution after cleaning with the alkaline cleaner and before contact with the Group IIIB and/or IVB metal-containing compound. Examples of rinse solutions include mild or strong acidic cleaners such as the dilute nitric acid solutions commercially available and conventionally used in metal pretreatment processes.

It is an advantage of the present invention that after contact with the Group IIIB and/or IVB metal-containing compound, the substrate may be rinsed with water and coated directly, i.e., without a phosphating step as is conventional in the art. Coating may be done immediately or after a drying period at ambient or elevated temperature conditions.

The substrate that has been contacted with the Group IIIB and/or IVB metal-containing compound is then coated by non-electrolytic means with a composition comprising a film-forming resin. Any resin that forms a film can be used in the compositions of the present methods, absent compatibility problems. For example, resins suitable for either powder or liquid coating compositions can be used. A particularly suitable resin is one formed from the reaction of a polymer having at least one type of reactive functional group and a curing agent having functional groups reactive with the functional group of the polymer. The polymers can be, for example, acrylic, polyester, polyether or polyurethane, and can contain functional groups such as hydroxyl, carboxylic acid, carbamate, isocyanate, epoxy, amide and carboxylate functional groups.

The use in powder coatings of acrylic, polyester, polyether and polyurethane polymers having hydroxyl functionality is well known. Monomers for the synthesis of such polymers are typically chosen so that the resulting polymers have a Tg greater than 50° C. Examples of such polymers are described in U.S. Pat. No. 5,646,228 at column 5, line 1 to column 8, line 7, incorporated herein by reference.

Acrylic polymers and polyester polymers having carboxylic acid functionality are also suitable for powder coatings. Monomers for the synthesis of acrylic polymers having carboxylic acid functionality are typically chosen such that the resulting acrylic polymer has a Tg greater than 40° C., and for the synthesis of the polyester polymers having carboxylic acid functionality such that the resulting polyester polymer has a Tg greater than 50° C. Examples of carboxylic acid group-containing acrylic polymers are described in U.S. Pat. No. 5,214,101 at column 2, line 59 to column 3, line 23, incorporated herein by reference. Examples of carboxylic acid group-containing polyester polymers are described in U.S. Pat. No. 4,801,680 at column 5, lines 38 to 65, incorporated herein by reference.

The carboxylic acid group-containing acrylic polymers can further contain a second carboxylic acid group-containing material selected from the class of C₄ to C₂₀ aliphatic dicarboxylic acids, polymeric polyanhydrides, low molecular weight polyesters having an acid equivalent weight from about 150 to about 750, and mixtures thereof. This material is crystalline and can be a low molecular weight crystalline carboxylic acid group-containing polyester.

Also useful in the present powder coating compositions are acrylic, polyester and polyurethane polymers containing carbamate functional groups. Examples are described in WO Publication No. 94/10213, incorporated herein by reference. Monomers for the synthesis of such polymers are typically chosen so that the resulting polymer has a Tg greater than about 40° C.

Many of the polymers described above require the use of curing agents. Suitable curing agents generally include blocked isocyanates, polyepoxides, polyacids, polyols, anhydrides, polyamines, aminoplasts and phenoplasts. The appropriate curing agent can be selected by one skilled in the art depending on the polymer used. For example, blocked isocyanates are suitable curing agents for hydroxy and primary and/or secondary amino group-containing materials. Examples of blocked isocyanates are those described in U.S. Pat. No. 4,988,793, column 3, lines 1 to 36, incorporated herein by reference. Polyepoxides suitable for use as curing agents for COOH functional group-containing materials are described in U.S. Pat. No. 4,681,811 at column 5, lines 33 to 58, incorporated herein by reference. Polyacids as curing agents for epoxy functional group-containing materials are described in U.S. Pat. No. 4,681,811 at column 6, line 45 to column 9, line 54, incorporated herein by reference. Polyols, materials having an average of two or more hydroxyl groups per molecule, can be used as curing agents for NCO functional group-containing materials and anhydrides, and are well known in the art. Polyols for use in the present invention are typically selected such that the resultant material has a Tg greater than about 50° C.

Anhydrides as curing agents for epoxy functional group-containing materials include, for example, trimellitic anhydride, benzophenone tetracarboxylic dianhydride, pyromellitic dianhydride, tetrahydrophthalic anhydride, and the like as described in U.S. Pat. No. 5,472,649 at column 4, lines 49-52, incorporated herein by reference. Aminoplasts as curing agents for hydroxy, COOH and carbamate functional group-containing materials are well known in the art. Examples of such curing agents include aldehyde condensates of glycoluril, which give high melting crystalline products useful in powder coatings. While the aldehyde used is typically formaldehyde, other aldehydes such as acetaldehyde, crotonaldehyde, and benzaldehyde can be used.

Hybrid resin systems, in which coreactive resins are used without a curing agent, can also be used. An example is an epoxy/polyether hybrid system.

The present additives can also be incorporated into film-forming resins that are liquid, that is, water-borne or solvent-borne systems. Such solvents include, for example, alcohols, ketones, aromatic hydrocarbons, glycol ethers, esters or mixtures thereof. Examples of polymers useful in forming the resin in the liquid coatings of the present invention include hydroxyl or carboxylic acid-containing acrylic copolymers, hydroxyl or carboxylic acid-containing polyester polymers, oligomers and isocyanate or hydroxyl-containing polyurethane polymers, and amine or isocyanate-containing polyureas. These polymers are further described in U.S. Pat. No. 5,939,491, column 7, line 7 to column 8, line 2; this patent, as well as the patents referenced therein, are incorporated by reference herein. Curing agents for these resins are also described in the '491 patent at column 6, line 6 to line 62. In solvent-based compositions, the solvent is generally present in amounts ranging from 5 to 80 weight percent based on total weight of the composition, such as 30 to 50 percent. These amounts can be even higher for water-based compositions.

The powder coating compositions of the present invention may optionally contain additional additives such as waxes for flow and wetting, flow control agents, such as poly(2-ethylhexyl)acrylate, degassing additives such as benzoin and MicroWax C, adjuvant resin to modify and optimize coating properties, antioxidants, ultraviolet (UV) light absorbers and catalysts. Examples of useful antioxidants and UV light absorbers include those available commercially from Ciba-Geigy under the trademarks IRGANOX and TINUVIN. These optional additives, when used, are typically present in amounts up to 20 percent by weight, based on total weight of the coating.

The liquid coating compositions of the present invention can similarly contain optional additives such as plasticizers, antioxidants, light stabilizers, UV absorbers, thixotropic agents, anti-gassing agents, organic cosolvents, biocides, surfactants, flow control additives and catalysts. Any such additives known in the art can be used, absent compatibility problems.

The powder coating compositions are most often applied by spraying, and in the case of a metal substrate, by electrostatic spraying, or by the use of a fluidized bed. The powder coating can be applied in a single sweep or in several passes to provide a film having a thickness after cure of from about 1 to 10 mils (25 to 250 micrometers), usually about 2 to 4 mils (50 to 100 micrometers). Other standard methods for coating application can be employed such as brushing, dipping or flowing.

The liquid compositions of the invention can also be applied by any conventional method such as brushing, dipping, flow coating, roll coating, conventional and electrostatic spraying. Spray techniques are most often used. Typically, film thickness for liquid coatings can range between 0.1 and 5 mils, such as between 0.5 and 1.5 mils, or about 1.0 mils.

Generally, after application of the coating composition, the coated substrate is baked at a temperature sufficient to cure the coating. Metallic substrates with powder coatings are typically cured at a temperature ranging from 250° F. to 500° F. (121.1° C. to 260.0° C.) for 1 to 60 minutes, or from 300° F. to 400° F. (148.9° C. to 204.4° C.) for 15 to 30 minutes.

Several liquid formulations can be cured at ambient temperature, such as those using a polyisocyanate or polyanhydride curing agent, or they can be cured at elevated temperatures to hasten the cure. An example would be forced air curing in a down draft booth at about 40° C. to 60° C., which is common in the automotive refinish industry. The ambient temperature curable compositions are usually prepared as a two (2) package system in which the curing agent is kept separate from the polysiloxane containing the reactive functional group. The packages are combined shortly before application.

The thermally curable liquid compositions such as those using blocked isocyanate, aminoplast, phenoplast, polyepoxide or polyacid curing agent can be prepared as a one-package system. These compositions are cured at elevated temperatures, typically for 1 to 30 minutes at about 250° F. to about 450° F. (121° C. to 232° C.) with temperature primarily dependent upon the type of substrate used. Dwell time (i.e., time that the coated substrate is exposed to elevated temperature for curing) is dependent upon the cure temperatures used as well as wet film thickness of the applied coating composition.

Untreated metal substrates coated by the methods of the present invention demonstrate good corrosion resistance as determined by salt spray corrosion resistance testing. The level of corrosion resistance that is achieved is unexpected since the phosphating step has been eliminated, as have a number of other additives reported in the art as being beneficial for corrosion protection; the additional corrosion protection offered by E-coats has also been eliminated in the present method. The relatively simple process using the relatively simple Group IIIB and/or IVB metal-containing composition will be especially appropriate for use in operations where reduced energy requirements are desired; in operations where space or economic constraints preclude use of more than one pretreatment solution; in applications using non-electrolytic coatings; in applications involving mixed metals; and in applications in which chrome-free and heavy metal-free solutions are desired.

The present invention is also directed to a metal substrate coated by any of the methods described herein.

As used herein, unless otherwise specified, all numbers such as those expressing values, ranges, amounts or percentages may be read as if prefaced by the word “about”, even if the term does not expressly appear. Also, any numerical range recited herein is intended to include all sub-ranges subsumed therein. Also, as used herein, the term “polymer” is meant to refer to oligomers and both homopolymers and copolymers; the prefix “poly” refers to two or more.

### EXAMPLES

The following examples are intended to illustrate the invention, and should not be construed as limiting the invention in any way.

### Example 1

Untreated cold rolled steel (“CRS”), two-sided electrogalvanized (“EG”) (EZG-60G) steel, and aluminum (“AI”) (AI 6016-T6) test panels were purchased from ACT Laboratories of Hillsdale, Mich. Each panel was about 10.16 centimeters (“cm”) wide, about 15.24 cm long and about 0.76 to 0.79 millimeters (“mm”) thick. The test panels were treated according to one or more of the stages described in Table 1 and as further indicated below.

TABLE 1

| Stage | Process | Description |
|---|---|---|
| 1 | Clean | CHEMKLEEN 611L¹ (2% by volume) sprayed |
| | | at 140° F. for 1 minute |
| 2 | Rinse | Tap water, 15-30 second immersion, ambient |
| | | temperature |
| 3 | Treat | Fluorozirconic acid² (FZA; pH 4.5) sprayed at |
| | | ambient temperature for 60 seconds |
| 4 | Rinse | Deionized water, 15-30 second immersion, |
| | | ambient temperature |
| 5 | Dry | Blow dry with warm air, 30-60 seconds |

¹Alkaline-based cleaner commercially available from PPG Industries, Inc., Pittsburgh, Pennsylvania
²Available as a 45% solution from Alfa Aesar, Ward Hill, Massachusetts; two different concentrations were tested-398 ppm and 1136 ppm.

As used herein, “ambient temperature” means air temperature of about 20-26° C. The pretreatment compositions used in Stage 3 of the above process were adjusted to a pH of 4.5 with 10 percent ammonium hydroxide, measured at ambient temperatures using an Accumet Research Model AR15 pH meter, commercially available from Fisher Scientific. The solution was sprayed onto the panels in a standard pretreatment tunnel washer.

Metal panels treated using the procedure described in Table 1 were evaluated for corrosion resistance. Tested panels include control panels that were cleaned and rinsed but not treated, and control panels that were phosphated with STRATAGUARD 52102, an iron phosphating solution, and rinsed with either deionized water (DIW) or CHEMSEAL 59, a non-chrome containing post-rinse solution (all commercially available PPG Industries, Inc.). For comparative purposes, panels purchased from ACT Laboratories that had been pretreated with BONDERITE 1000, an iron phosphate commercially available from Henkel Surface Technology, Madison Heights, Mich., were also tested.

Panels were painted with either SPECTRACRON SPE, a polyester-based solventborne topcoat, or ENVIROCRON PCF20128, a powder topcoat, both commercially available from PPG Industries, Inc. White and tan colored versions of the topcoat were used as indicated below. Panels were cured in an electric oven according to the prescribed bake schedules in the product literature. The overall coating thickness was about 30 microns (1.2 mils). The corrosion resistance of the panels was evaluated using salt spray testing performed according to ASTM B117, for a period of 144 hours. After testing was completed, panels were taped off to remove corrosion products and delaminated paint. Test panels were run in triplicate. The total paint loss from scribe values in Table 2 (white liquid paint), Table 3 (tan liquid paint), and Table 4 (tan powder) below are reported as the three panel average of the average of the loss measured at 6 points along the scribe of each panel.

TABLE 2
Salt Spray Test Results (144 hours) SPECTRACON White

| | Total Paint Loss from Scribe (mm) | | |
|---|---|---|---|
| TREATMENT APPLIED | CRS | EG | Al |
| Clean and rinse only (Stages 1- | 20.0 | 17.77 | 1.36 |
| 2 in Table 1) | | | |
| FZA (398 ppm) (Stages 1-5) | 9.60 | 7.36 | 0.96 |
| FZA (1136 ppm) (Stages 1-5) | 11.81 | 8.47 | 0.54 |
| STRATAGUARD 52102/DIW | 10.18 | 20.81 | 7.38 |
| STRATAGUARD | 4.88 | 10.53 | 2.87 |
| 52102/CHEMSEAL 59 | | | |
| BONDERITE 1000/DIW | 21.53 | — | — |

TABLE 3
Salt Spray Test Results (144 hours) SPECTRACON Tan

| | Total Paint Loss from Scribe (mm) | | |
|---|---|---|---|
| TREATMENT APPLIED | CRS | EG | Al |
| Clean and rinse only (Stages 1- | — | — | — |
| 2) | | | |
| FZA (398 ppm) (Stages 1-5) | 7.21 | 4.35 | 1.42 |
| FZA (1136 ppm) (Stages 1-5) | 9.22 | 3.94 | 1.13 |
| STRATAGUARD 52102/DIW | 8.95 | 13.91 | 10.29 |
| STRATAGUARD | 5.72 | 3.73 | 2.13 |
| 52102/CHEMSEAL 59 | | | |
| BONDERITE 1000/DIW | 19.85 | — | — |

TABLE 4
Salt Spray Test Results
(1000 hours for CRS and Al; 500 hours for EG) ENVIROCRON Tan

| | Total Paint Loss from Scribe (mm) | | |
|---|---|---|---|
| TREATMENT APPLIED | CRS | EG | Al |
| Clean and rinse only (Stages 1- | 13.45 | — | — |
| 2) | | | |
| FZA (398 ppm) (Stages 1-5) | 4.0 | 8.0 | 0.0 |
| FZA (1136 ppm) (Stages 1-5) | 11.33 | 8.0 | 0.0 |
| STRATAGUARD 52102/DIW | 4.23 | 6.0 | — |
| STRATAGUARD | 3.5 | 5.67 | 0.0 |
| 52102/CHEMSEAL 59 | | | |
| BONDERITE 1000/DIW | 9.67 (500 hrs) | — | — |

The data in Tables 2 and 4 above demonstrates that the process described in Table 1 including a pretreatment with fluorozirconic acid offers a useful alternative pretreatment method to standard phosphate conversion coatings. The effectiveness of this pretreatment on a variety of substrates, particularly on cold rolled steel, an inherently difficult substrate on which to inhibit corrosion, is highly desirable.

The coating compositions of the present invention provide: (1) a heavy metal-free alternative to conventional phosphating compositions; (2) a simpler operating procedure effective at ambient temperatures; and (3) a coating for objects comprised of mixed metallic substrates.

Whereas particular embodiments of this invention have been described above for purposes of illustration, it will be evident to those skilled in the art that numerous variations of the details of the present invention may be made without departing from the invention as defined in the appended claims.

Therefore, we claim:

1. A method for applying a coating to an untreated metal substrate comprising:
a) contacting the substrate with a Group IIIB and/or IVB metal-containing compound that is essentially free of:
i) accelerators needed to form phosphate, oxide or other conversion coatings;
ii) phosphate;
iii) zinc in a concentration of 1 to 30 g/l; and
iv) polymeric material; and
b) coating the substrate with a composition comprising a film-forming resin by non-electrolytic means, but when the substrate is aluminum the Group IIIB and/or IVB metal-containing compound does not contain both fluoride and either zirconium, hafnium or titanium.

2. The method of claim 1 further comprising the step of cleaning the metal surface with an alkaline cleaner before contacting with the Group IIIB and/or IVB metal-containing compound.

3. The method of claim 2 further comprising the step of rinsing the metal surface with an aqueous acidic solution after cleaning with the alkaline cleaner and before contacting with the Group IIIB and/or IVB metal-containing compound.

4. The method of claim 1, wherein the substrate is contacted with the Group IIIB and/or IVB metal-containing compound that is at a temperature of about 20° C. to 65° C.

5. The method of claim 1, wherein the substrate is contacted with the Group IIIB and/or IVB metal-containing compound by immersion.

6. The method of claim 1, wherein the Group IIIB and/or IVB metal-containing compound is a zirconium compound.

7. The method of claim 6, wherein the zirconium compound is hexafluorozirconic acid.

8. The method of claim 6, wherein the zirconium compound is present in a concentration of 100 to 500 ppm Zr.

9. The method of claim 1, wherein the metal substrate is cold rolled steel.

10. The method of claim 1, wherein the metal substrate is zinc coated steel.

11. The method of claim 1, wherein the metal substrate is aluminum.

12. A substrate coated by the method of claim 1.

13. The method of claim 1, wherein the metal substrate is nonferrous.

14. The method of claim 1, wherein the composition comprising a film-forming resin is a liquid.

15. The method of claim 1, wherein the composition comprising a film-forming resin is a powder.

16. A method for coating an untreated metal substrate comprising:
a) contacting the substrate with a composition consisting essentially of a Group IIIB and/or IVB metal-containing compound; and
b) coating the substrate with a composition comprising a film-forming resin by non-electrolytic means.
